(19) United States
(12) Patent Application Publication
(10) Pub. No.: US 2020/0349416 A1
(43) Pub. Date: Nov. 5, 2020

(54) DETERMINING COMPUTER-EXECUTED ENSEMBLE MODEL

(71) Applicant: Alibaba Group Holding Limited, George Town (KY)

(72) Inventors: Xinxing Yang, Hangzhou (CN); Longfei Li, Hangzhou (CN); Jun Zhou, Hangzhou (CN)

(73) Assignee: Alibaba Group Holding Limited, George Town (KY)

(21) Appl. No.: 16/812,105

(22) Filed: Mar. 6, 2020

Related U.S. Application Data
(63) Continuation of application No. PCT/CN2020/071691, filed on Jan. 13, 2020.

(30) Foreign Application Priority Data
May 5, 2019 (CN) 201910368113.X

(51) Int. Cl. G06N 3/04; G06N 3/08

(52) U.S. Cl. CPC G06N 3/0454; G06N 3/08

(57) ABSTRACT

Implementations of the present specification provide a method for determining a computer-executed ensemble model. The method includes: obtaining a current ensemble model and a plurality of untrained candidate submodels; integrating each of the plurality of candidate submodels into the current ensemble model to obtain a plurality of first candidate ensemble models; training at least the plurality of first candidate ensemble models to obtain a plurality of second candidate ensemble models after this training; performing performance evaluation on each of the plurality of second candidate ensemble models to obtain corresponding performance evaluation results; determining, based on the performance evaluation results, an optimal candidate ensemble model with optimal performance from the plurality of second candidate ensemble models; and updating the current ensemble model with the optimal candidate ensemble model if the performance of the optimal candidate ensemble model satisfies a predetermined condition.

### CROSS-REFERENCE TO RELATED APPLICATIONS

This application is a continuation of PCT Application No. PCT/CN2020/071691, filed on Jan. 13, 2020, which claims priority to Chinese Patent Application No. 201910368113.X, filed on May 5, 2019, and each application is hereby incorporated by reference in its entirety.

### TECHNICAL FIELD

One or more implementations of the present disclosure relate to the field of machine learning, and in particular, to automated methods and devices for determining a computer-executed ensemble model.

### BACKGROUND

Ensemble learning is a machine learning method in which a series of individual learners (or known as submodels) are used, and then the learning results are integrated to obtain a better learning effect than that of a single learner. In the ensemble learning, first a “weak learner” is usually selected, and then several learners are generated using methods such as sample set perturbation, input characteristic perturbation, output representation perturbation, and algorithm parameter perturbation, and then the learners are integrated to obtain a “strong learner” (which is also known as an ensemble model) with better precision.

### SUMMARY

One or more implementations of the present specification describe methods and devices for determining a computer-executed ensemble model, so that submodels can be automatically selected from some basic candidate submodels to form a high-performance ensemble model, and dependence on expert experience and manual intervention can be greatly alleviated.

According to a first aspect, a method for determining a computer-executed ensemble model is provided, including: obtaining a current ensemble model and a plurality of untrained candidate submodels; integrating each of the plurality of candidate submodels into the current ensemble model to obtain a plurality of first candidate ensemble models; training at least the plurality of first candidate ensemble models to obtain a plurality of second candidate ensemble models after this training; performing performance evaluation on each of the plurality of second candidate ensemble models to obtain corresponding performance evaluation results; determining, based on the performance evaluation results, an optimal candidate ensemble model with optimal performance from the plurality of second candidate ensemble models; and updating the current ensemble model with the optimal candidate ensemble model if the performance of the optimal candidate ensemble model satisfies a predetermined condition.

In an implementation, any two of the plurality of candidate submodels are based on the same or different types of neural networks.

In an implementation, the plurality of candidate submodels include a first candidate submodel and a second candidate submodel, and the first candidate submodel and the second candidate submodel are based on the same type of neural network, and have different hyperparameters for the neural network.

Further, in a specific implementation, the same type of neural network is a deep neural network (DNN), and the hyperparameters include the quantity of hidden layers in the DNN network structure, the quantity of neural units of each hidden layer in the plurality of hidden layers, and a manner of connection between any two of the plurality of hidden layers.

In an implementation, if the current ensemble model is not empty, the training at least the plurality of first candidate ensemble models further includes performing this training on the current ensemble model.

In an implementation, the performance evaluation results include function values of a loss function that are corresponding to the plurality of second candidate ensemble models; and determining, based on the performance evaluation results, an optimal candidate ensemble model with optimal performance from the plurality of second candidate ensemble models includes: determining a second candidate ensemble model corresponding to a minimum value of a function value of the loss function as the optimal candidate ensemble model.

In an implementation, the performance evaluation results include an area under a receiver operation characteristic (ROC) curve (AUC) value corresponding to each of the plurality of second candidate ensemble models; and determining, based on the performance evaluation results, an optimal candidate ensemble model with optimal performance from the plurality of second candidate ensemble models includes: determining a second candidate ensemble model corresponding to a maximum AUC value as the optimal candidate ensemble model.

In an implementation, updating the current ensemble model with the optimal candidate ensemble model if the performance of the optimal candidate ensemble model satisfies a predetermined condition includes: updating the current ensemble model with the optimal candidate ensemble model if the performance of the optimal candidate ensemble model is superior to that of the current ensemble model.

In an implementation, after determining an optimal candidate ensemble model with optimal performance from the plurality of second candidate ensemble models, the method further includes: determining the current ensemble model as the final ensemble model if the performance of the optimal candidate ensemble model does not satisfy a predetermined condition.

In an implementation, after updating the current ensemble model with the optimal candidate ensemble model, the method further includes: determining whether the quantity of updates corresponding to the current ensemble model reaches a predetermined quantity of updates; and when the quantity of updates reaches the predetermined quantity of updates, determining the updated current ensemble model as the final ensemble model.

In an implementation, the plurality of second candidate ensemble models after training include a retrained model obtained after this training is performed on the current ensemble model; and after updating a current ensemble model with the optimal candidate ensemble model, the method further includes: determining whether the optimal candidate ensemble model is the retrained model; and when the optimal candidate ensemble model is the retrained model, determining the retrained model as the final ensemble model.

According to a second aspect, a device for determining a computer-executed ensemble model is provided, where the device includes: an acquisition unit, configured to obtain a current ensemble model and a plurality of untrained candidate submodels; an integration unit, configured to integrate each of the plurality of candidate submodels into the current ensemble model to obtain a plurality of first candidate ensemble models; a training unit, configured to train at least the plurality of first candidate ensemble models to obtain a plurality of second candidate ensemble models after this training; an evaluation unit, configured to perform performance evaluation on each of the plurality of second candidate ensemble models to obtain corresponding performance evaluation results; a selection unit, configured to determine, based on the performance evaluation results, an optimal candidate ensemble model with optimal performance from the plurality of second candidate ensemble models; and an updating unit, configured to update the current ensemble model with the optimal candidate ensemble model if the performance of the optimal candidate ensemble model satisfies a predetermined condition.

According to a third aspect, a computer readable storage medium is provided, where the medium stores a computer program, and when the computer program is executed on a computer, the computer is enabled to perform the method according to the first aspect.

According to a fourth aspect, a computing device is provided, including a memory and a processor, where the memory stores executable code, and when the processor executes the executable code, the method of the first aspect is implemented.

According to the method for determining a computer-executed ensemble model disclosed in the implementations of the present specification, submodels can be automatically selected from some basic candidate submodels to form a high-performance ensemble model, and dependence on expert experience and manual intervention can be greatly alleviated. In particular, when the method is used to determine the DNN ensemble model, the complexity of artificial DNN design is greatly reduced. In addition, practices have shown that the DNN training method based on auto-integration can make the performance of the DNN ensemble model superior to that of a manually parameter-tuned DNN model.

### BRIEF DESCRIPTION OF DRAWINGS

To describe the technical solutions in the implementations of the present specification more clearly, the following briefly introduces the accompanying drawings required for describing the implementations. Clearly, the accompanying drawings in the following description are merely some implementations of the present specification, and a person of ordinary skill in the field may still derive other drawings from these accompanying drawings without creative efforts.

FIG. 1 is a block diagram illustrating implementation of a method for determining an ensemble model, according to an implementation.

FIG. 2 is a flowchart illustrating a method for determining an ensemble model, according to an implementation;

FIG. 3 is a block diagram illustrating a flowchart of a method for determining an ensemble model, according to an implementation; and

FIG. 4 is a structural diagram illustrating a device for determining an ensemble model, according to an implementation.

### DESCRIPTION OF IMPLEMENTATIONS

The solutions provided in the present specification are described below with reference to the accompanying drawings.

The implementations of the present specification provide methods for determining a computer-executed ensemble model. The following first describes the specification concept and application scenarios of the method.

In many technical scenarios, a machine learning model needs to be used for data analysis, for example, a typical classification model needs to be used to classify users. Such classification can include, for the sake of network security, dividing user accounts into user accounts in normal state and user accounts in abnormal state, or classifying user access operations into safe operations, low-risk operations, medium-risk operations, and high-risk operations to improve the network security. In another example, the classification of users can also include dividing the users into a plurality of groups for service optimization customization considerations, thereby purposefully providing personalized services for the users in different groups, to improve user experience.

In some cases, the ensemble learning heavily depends on expert experience and manual parameter-tuning that can be costly and time-consuming.

In order to achieve a better machine learning effect, ensemble learning can be used. Currently, in ensemble learning, the type and quantity of submodels (or referred to as individual learners) ensemble in the ensemble model (or referred to as an ensemble learner) need to be determined through manual parameter-tuning. As a result, the inventors propose a method for determining a computer-executed ensemble model. With this method, automatic integration can be implemented; that is, in a process of integrating the learners, performance of the learners is automatically evaluated, and learns are automatically selected to form a high-performance learner combination, that is, to form a high-performance ensemble model.

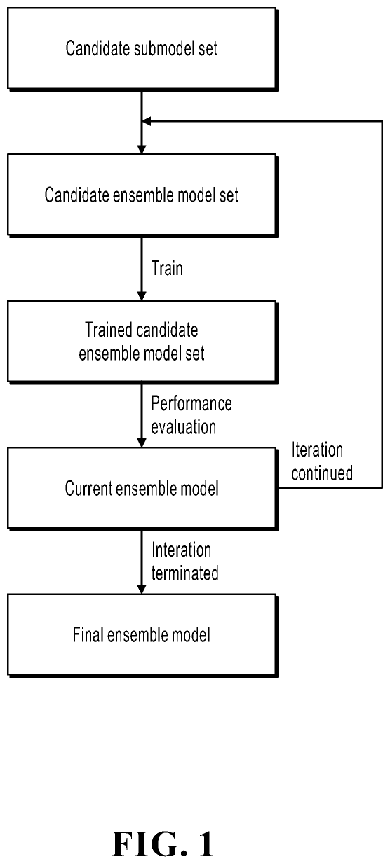

In an example, FIG. 1 shows a block diagram illustrating implementation of the determining method. First, a plurality of candidate submodels are sequentially combined into the current ensemble model to obtain a plurality of candidate ensemble models; next, a plurality of candidate ensemble models are trained to obtain a plurality of candidate ensemble models after training; and then, the current ensemble model is updated by evaluating the performance of several candidate ensemble models after training. Initially, the current ensemble model is empty. With the quantity of iterations increases, more candidate submodels are combined, which continuously improves performance of the current ensemble model. When the iteration is terminated, the updated current ensemble model is determined as the final ensemble model.

In addition, the inventors also found that with the development of big data technologies and deep learning, the deep neural network (DNN) is used as a structure of the trained model in more and more scenarios. For example, in search, recommendation, and advertising scenarios, the DNN model plays an important role and achieves better results. However, because data amount is increasing and scenarios become more complex, the network structures and parameters in the DNN model are increasing. As a result, currently, most of algorithm engineers are designing the network structures and debugging the parameters in the DNN model.

Based on the above, the inventors further propose that, in the previous method for determining an ensemble model, a plurality of manually set basic DNN structures can be used as the above candidate submodels, and then the candidate submodels can be automatically integrated to obtain a corresponding DNN ensemble model, so that the complexity of artificial DNN design can be greatly reduced. In addition, practices have shown that the DNN training method based on auto-integration can make the performance of the DNN ensemble model superior to that of a manually parameter-tuned DNN model.

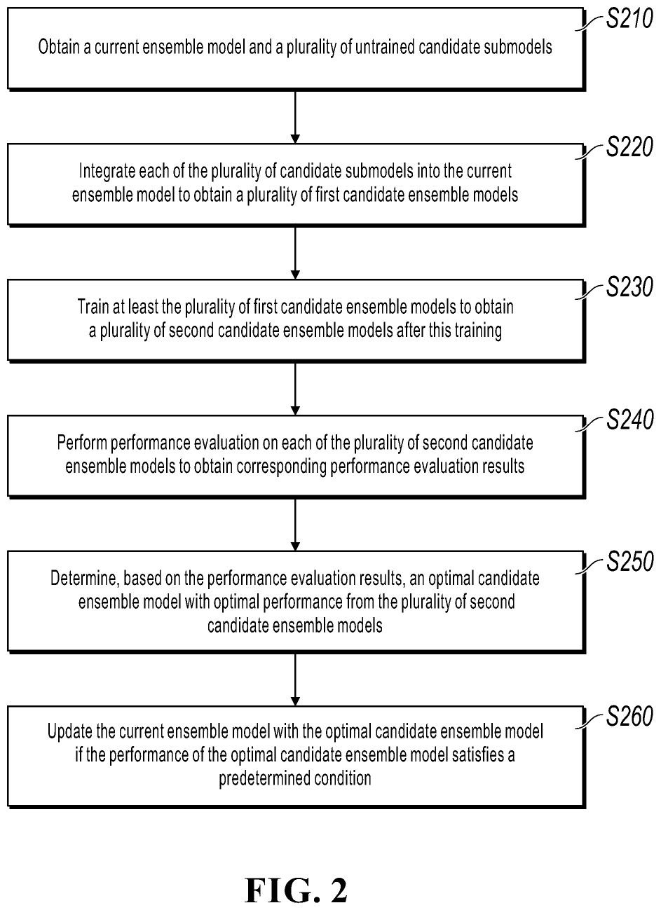

Next, the previous method is described in detail with reference to specific examples. Specifically, FIG. 2 is a flowchart illustrating a method for determining an ensemble model, according to an implementation. The method can be performed by any device, platform, or device cluster that has computation and processing capabilities. As shown in FIG. 2, the method includes the following steps: Step S210. Obtain a current ensemble model and a plurality of untrained candidate submodels; Step S220. Integrate each of the plurality of candidate submodels into the current ensemble model to obtain a plurality of first candidate ensemble models; Step S230. Train at least the plurality of first candidate ensemble models to obtain a plurality of second candidate ensemble models after this training; Step S240. Perform performance evaluation on each of the plurality of second candidate ensemble models to obtain corresponding performance evaluation results; Step S250. Determine, based on the performance evaluation results, an optimal candidate ensemble model with optimal performance from the plurality of second candidate ensemble models; and Step S260. Update the current ensemble model with the optimal candidate ensemble model if the performance of the optimal candidate ensemble model satisfies a predetermined condition. The following describes the specific execution methods of the previous steps with reference to specific examples.

In order to describe the method for determining an ensemble model more clearly, the following description is given first. Specifically, the two main problems that need to be alleviated in the integration algorithm are how to select several individual learners and which strategies should be selected to integrate the individual learners into a strong learner. Further, in the following implementations, emphasis is placed on determining a plurality of submodels in an ensemble model, i.e., on selection of individual learners. However, the combination strategy, that is, the strategy for combining the output results of the submodels in the ensemble model, can be predetermined, by related staff, to be any of the existing combination strategies as required.

In the following, the method for determining an ensemble model mainly includes selection of the submodels in the ensemble model. The specific steps for implementing the method are as follows:

First, in step S210, the current ensemble model and a plurality of untrained candidate submodels are obtained.

It is worthwhile to note that the untrained candidate submodels are individual learners to be ensemble into the current ensemble model. Initially, the current ensemble model is empty. By using the method disclosed in the implementations of the present specification, iterative integration is performed, that is, candidate submodels are continuously ensemble into the current ensemble model, so that the current ensemble model is continuously updated in the direction of performance improvement until the iteration termination condition is satisfied, and the current ensemble model obtained after a plurality of updates is determined as the final ensemble model. According to a specific example, the candidate submodels can be several individual classifiers (several weak classifiers), and correspondingly, the obtained final ensemble model is a strong classifier.

As for the source of candidate submodels, it can be understood that the untrained candidate submodels can be predetermined by related staff based on expert experience, specifically including selection of a machine learning algorithm based on candidate submodels and a setting of hyperparameters.

In addition, as for the selection of the machine learning algorithm, in an implementation, the plurality of candidate submodels can be based on a plurality of machine learning algorithms, including regression algorithm, decision tree algorithm, Bayesian algorithm, etc. In an implementation, the plurality of candidate submodels can be based on one or more of the following neural networks: Convolutional Neural Networks (CNN), Long Short-Term Memory (LSTM), DNN, etc. In a specific implementation, any two of the plurality of candidate submodels may be based on the same or different types of neural networks. In an example, the plurality of candidate submodels can all be based on the same type of neural network, for example, DNN.

In addition, as for the setting of hyperparameters, in an implementation, the candidate submodel can be based on a DNN network, and correspondingly, the hyperparameters that need to be set include the quantity of hidden layers in the DNN network structure, the quantity of neural units that each hidden layer in the plurality of hidden layers has, the manner of connection between any two of the plurality of hidden layers, and the like. In another implementation, the candidate submodel can use CNN convolutional neural network, and correspondingly, the hyperparameters to be set can also include the size of the convolutional kernel, the convolutional step size, etc.

It is worthwhile to note that any two of the plurality of candidate submodels are generally different from each other. In an implementation, for two candidate submodels based on the same type of neural network, different hyperparameters are usually set. In a specific implementation, the plurality of candidate submodels include the DNN-based first and second candidate submodels. Further, the first candidate submodel can be a fully connected network with hidden layer elements [16, 16], where [16, 16] indicates that the submodel includes two hidden layers and that the quantities of neural units in the two hidden layers are both 16; and the second candidate submodel may be a neural network with hidden layer elements [10, 20, 10], where [10, 20, 10] indicates that the submodel has three hidden layers, and that the quantities of neural units in the three hidden layers are 10, 20, and 10, respectively.

As such, the candidate submodel can be set by selecting the machine learning algorithm and setting hyperparameters.

The candidate submodels can be continuously combined into the ensemble model, which is then used as the current ensemble model. When this iteration is the first iteration, correspondingly, the current ensemble model obtained in this step is empty. When this current iteration is not the first iteration, the current ensemble model obtained in this step is not empty, that is, the current ensemble model includes several submodels.

As such, the current ensemble model and a plurality of predetermined candidate submodels can be obtained. Next, in step S220, the plurality of candidate submodels are separately ensemble into the current ensemble model to obtain a plurality of first candidate ensemble models.

It is worthwhile to note that, based on the previous description about ensemble learning, the meaning of the integration operation in this step can be understood from the following two aspects: In the first aspect, each candidate submodel is added to the current ensemble model, so that the candidate submodel and several submodels already included in the current ensemble model are combined together as a plurality of submodels in the corresponding first candidate ensemble model. In the second aspect, based on the predetermined combination strategy, the output results of the plurality of submodels obtained in the first aspect are combined, and the combined results are used as the output results of the first candidate ensemble model. In addition, when the current ensemble model is empty, the first candidate ensemble model includes a single candidate submodel; and correspondingly, the output result of the single candidate submodel is the output result of the first candidate ensemble model.

Specifically, with respect to the first aspect, in one case, the current ensemble model is empty, and the first candidate ensemble model obtained includes the single candidate submodel. In a specific implementation, Sᵢ is used to represent the i^{th} candidate submodel, and L is used to indicate the total quantity of submodels corresponding to the plurality of candidate submodels, and values of i are 1 to L.

Correspondingly, Sᵢ is ensemble into the empty current ensemble model to obtain the first candidate ensemble model Sᵢ, and then L first candidate ensemble models can be obtained.

In another case, the current ensemble model is a model obtained by through n iterations and trainings, which includes a set R of several trained submodels. Specifically, Sᵢ can be used to represent the i^{th} candidate submodel (these candidate submodels are all untrained original submodels); in addition, the set R includes several trained submodels Sⱼⁿ, where Sⱼⁿ represents the trained submodel that is obtained in the n^{th} iteration and that corresponds to the original submodel Sⱼ. In a specific implementation, assume that this iteration is the second iteration, and the module set R corresponding to the current ensemble model is S₁¹ obtained by training S₁. Correspondingly, after Sᵢ is ensemble into the current ensemble model S₁¹, the obtained first candidate model includes submodels S₁¹ and Sᵢ, and then L first candidate ensemble models can be obtained.

With regard to the second aspect, the combination strategy can be predetermined by related staff as required, including selecting the combination strategy from a plurality of existing combination strategies. Specifically, in an implementation, the output results of the submodels included in the ensemble model are continuous data, and correspondingly, the averaging method can be selected as the combination strategy. In a specific implementation, the arithmetic averaging method can be selected; that is, the output results of the submodels in the ensemble model are first arithmetically averaged, and then the obtained result is used as the output result of the ensemble model. In another specific implementation, the weighted averaging method can be selected; that is, weighted averaging is performed on output results of the submodel in the ensemble model, and then the obtained result is used as the output result of the ensemble model. In another implementation, the output results of the submodels are discrete data, and correspondingly, the voting method can be selected as the combination strategy. In a specific implementation, the absolute majority voting method, or the relative majority voting method, or the weighted voting method, etc., can be selected. According to a specific example, when the weighted averaging method or weighted voting method is selected as the combination strategy, the weighted coefficients of the submodels in the ensemble model and that correspond to the final output result can be determined in the training process of the ensemble model.

A plurality of first candidate ensemble models can be obtained through the previous integration operations. Then, in step S230, at least the plurality of first candidate ensemble models are trained to obtain a plurality of second candidate ensemble models after this training.

First, it is worthwhile to note that “this training” corresponds to this iteration to distinguish this training from the training involved in other iterations.

In an implementation, this iteration is the first iteration, and the current ensemble model is empty. Correspondingly, in this step, only a plurality of first candidate ensemble models need to be trained. In a specific implementation, the same training data can be used to train the first candidate ensemble models to determine their model parameters. In an example, as described above, Sᵢ is used to represent a candidate submodel, Sⱼⁿ is used to represent the trained submodel that corresponds to Sⱼ and that is obtained after the n^{th} iteration; and correspondingly, when this iteration is the first iteration, the first candidate ensemble model includes the submodel Sᵢ, and the obtained second candidate ensemble model includes the submodel Sᵢ¹.

In another implementation, this iteration is not the first iteration, and the current ensemble model includes the set R of submodels obtained through training in the previous iteration. In this case, the first candidate ensemble model resulting from the corresponding integration includes a combination of newly added candidate submodels and the existing submodels in the set R. In an implementation, in this training, the newly added submodels and the submodels in the set R are jointly trained. In another implementation, when the first candidate ensemble model is trained, only the model parameters of the newly added candidate submodels in the model parameters in the model parameters of the trained submodels included in the fixed set R are adjusted and determined. In a specific implementation, as described above, assume that this iteration is the second iteration and the first candidate ensemble model includes the submodels S₁¹ and Sᵢ. In this case, in this training, the parameters in S₁¹ can be set to fixed values, and only the parameters in Sᵢ are trained, to obtain the second candidate ensemble model (S₁², Sᵢ²), where S₁² is the same as S₁¹ in the previous iteration.

According to an implementation, in step S230, if this iteration is not the first iteration, in addition to training the first candidate ensemble model, this training can also be performed on the current ensemble model (the training is also referred to as retraining), to obtain a retrained model after the training. In an example, the training data used for performing this training on the current ensemble model can be different from the training data used in the previous iteration to retrain the current ensemble model. In addition, in an example, the same training data can be used to train the models involved in this training. In another example, different training data can be randomly extracted from an original dataset to train the models involved in the training.

In addition, during this training on the current ensemble model, in an implementation, the parameters in all trained submodels can be adjusted again. In another implementation, the parameters in some of the trained submodels can be adjusted, while the parameters in other trained submodels remain unchanged. In a specific implementation, as described above, it is assumed this iteration is the third iteration, and the current ensemble model includes the trained submodels S₁² and S₃². Further, in an example, the parameters in both S₁² and S₃² can be adjusted. Therefore, in the obtained retrained model (S₁³, S₃³), S₁³ is different from S₁² obtained in the previous iteration, and S₃³ is also different S₃² obtained in the previous iteration. In another example, only the parameters in S₃² are adjusted, while the parameters in S₁² remain unchanged. Therefore, in the obtained retrained model (S₁³, S₃³), S₁³ is the same as S₁² obtained in the previous iteration, but S₃³ is different from S₃² obtained in the previous iteration.

Further, if the combination strategy set for the ensemble model is the weighted average method or the weighted voting method, when the first candidate ensemble model and/or the current ensemble model are/is trained, the parameters that need to be adjusted include the learning parameters that are used in the new ensemble model to determine the output results of the submodels, and the weighting coefficients that correspond to the submodel in the first candidate ensemble model and/or the current ensemble model and that are used to determine the final output result of the ensemble model.

In a scenario in which the ensemble model is applied to user classification, in step S230, the submodels can be trained by using labeled user sample data. For example, users can be labeled as a plurality of categories as sample labels. For example, user accounts can be divided normal accounts and abnormal accounts as second-class labels, and sample characteristics are user characteristics, which can specifically include user attribute characteristics (such as gender, age, and occupation), historical behavior characteristics (such as the quantity of successful transfers and the quantity of failed transfers), etc. The ensemble model that is obtained through training based on such user sample data can be used as a classification model for classifying users.

As such, a plurality of second candidate ensemble models after this training can be obtained. Next, in step S240, performance evaluation is separately performed on each of the plurality of second candidate ensemble models to obtain a corresponding performance evaluation result. Next, in step S250, an optimal candidate ensemble model with optimal performance is determined, based on the performance evaluation results, from the plurality of second candidate ensemble models.

Specifically, a plurality of evaluation functions can be selected to implement performance evaluation, including using the evaluation function value of the second candidate ensemble model that is obtained based on evaluation data (or evaluation samples) as the corresponding performance evaluation result.

Further, in an implementation, a loss function can be selected as an evaluation function, and correspondingly, evaluation results obtained by performing performance evaluation on a plurality of second candidate ensemble models include a plurality of function values corresponding to the loss function. Based on this, step S250 can include: determining the second candidate ensemble model corresponding to the minimum value of the plurality of obtained function values as the optimal candidate ensemble model.

In a specific implementation, the loss function specifically includes the following formula:

$${ℒ}_{i} = \frac{1}{K} {Σ}_{k}^{K} ℒ ( ( {Σ}_{j} {α}_{j} {S}_{j} ( {x}_{k} ) + β {S}_{i} ( {x}_{k} ) ) , {y}_{k} ) + R ( Σ {S}_{j} , {S}_{i} ) \qquad ( 1 )$$

where [symbol] ᵢ indicates the value of the loss function of the i^{th} second candidate ensemble model; k indicates a quantity of an evaluation sample; K indicates the total quantity of evaluation samples; xₖ indicates sample characteristics of the k^{th} evaluation sample; yₖ indicates the sample label of the k^{th} evaluation sample; Sⱼ indicates the j^{th} trained submodel in the model set R of the current ensemble model j; αⱼ indicates the weighting coefficient that is of the j^{th} trained submodel and that corresponds to the combination strategy; Sᵢ indicates the newly ensemble candidate submodel in the i^{th} second candidate ensemble model; β indicates the weighting coefficient that is of the newly ensemble candidate submodel and that corresponds to the combination strategy; and R(Σ Sⱼ, Sᵢ) indicates a regularization function, which is used to control the size of the model, and prevent overfitting due to an extremely complex model.

In another implementation, the area under curve (AUC) under a receiver operating characteristic (ROC) curve can be selected as the evaluation function. Correspondingly, the evaluation results obtained through performance evaluation of a plurality of second candidate ensemble models include a plurality of AUC values. Based on this, step S250 may include determining a second candidate ensemble model corresponding to a maximum AUC value as the optimal candidate ensemble model.

The following describes the evaluation samples. In an implementation, as described above, when the ensemble model is applied to a user classification scenario, which, for example, specifically corresponds to a scenario in which user accounts are divided into normal accounts and abnormal accounts, the sample characteristics included in the evaluation samples are user characteristics, which can specifically include user attribute characteristics (such as gender, age, and occupation), historical behavior characteristics (such as the quantity of successful transfers and the quantity of failed transfers), etc. In addition, the sample label included therein is a specific category label, for example, which may include a normal account and an abnormal account.

The optimal candidate ensemble model can be determined through performance evaluation. Further, if the performance of the optimal candidate ensemble model satisfies a predetermined condition, step S260 is performed to update the current ensemble model with the optimal candidate ensemble model.

In an implementation, the predetermined condition can be predetermined by related staff as required. In a specific implementation, that the performance of the optimal candidate ensemble model satisfies a predetermined condition can include that the performance of the optimal candidate ensemble model is superior to that of the current ensemble model. In an example, that the performance of the optimal candidate ensemble model is superior to that of the current ensemble model specifically includes that the function value of the loss function of the optimal candidate ensemble model on an evaluation sample is less than the function value of the loss function of the current ensemble model on the same evaluation sample. In another example, that the performance of the optimal candidate ensemble model is superior to that of the current ensemble model specifically includes that the AUC value of the optimal candidate ensemble model on an evaluation sample is greater than the AUC value of the current ensemble model on the same evaluation sample.

In another specific implementation, that the performance of the optimal candidate ensemble model satisfies a predetermined condition can include that the performance evaluation result of the optimal candidate ensemble model is superior to a predetermined performance standard. In an example, that the performance evaluation result of the optimal candidate ensemble model is superior to a predetermined performance standard can specifically include that the function value of the loss function of the optimal candidate ensemble model on an evaluation sample is less than a corresponding predetermined threshold. In another example, that the performance evaluation result of the optimal candidate ensemble model is superior to a predetermined performance standard may specifically include that AUC value of the optimal candidate ensemble model on an evaluation sample is greater than a corresponding predetermined threshold.

As such, the current ensemble model can be updated through step S210 to step S260.

Further, in an implementation, after step S260 is performed, the method can further include determining whether the current iteration satisfies the iteration termination condition. In a specific implementation, it can be determined whether the quantity of updates corresponding to the current ensemble model reaches a predetermined quantity of updates, for example, 5 times or 6 times. In another specific implementation, the plurality of second candidate ensemble models obtained in step S230 include a retrained model obtained after this training is performed on the current ensemble model obtained in step S210. Based on this, determining whether the current iteration satisfies the iteration termination condition can include determining whether the optimal candidate ensemble model is the retrained model.

Further, on one hand, if the current iteration does not satisfy the iteration termination condition, the next iteration is performed based on the updated current ensemble model. In a specific implementation, that the current iteration does not satisfy the iteration termination condition corresponds to that the quantity of updates does not reach a predetermined quantity of updates. In an example, the quantity of updates corresponding to this iteration is 2, the predetermined quantity of updates is 5, and therefore it can be determined that the predetermined quantity of updates is not reached. In another specific implementation, that the current iteration does not satisfy the iteration termination condition corresponds to that the optimal candidate ensemble model is not the retrained model.

On the other hand, if the current iteration satisfies the iteration termination condition, the updated current ensemble model is determined as the final ensemble model. In a specific implementation, that the current iteration satisfies the iteration termination condition corresponds to that the quantity of updates reaches a predetermined quantity of times. In an example, the quantity of updates corresponding to this iteration is 5, and the predetermined quantity of updates is 5, and therefore it can be determined that the predetermined quantity of updates is reached. In another specific implementation, that the current iteration satisfies the iteration termination condition corresponds to that the optimal candidate ensemble model is the retrained model.

In addition, it is worthwhile to note that, after the optimal ensemble model is determined by step S250, if the performance of the optimal candidate ensemble model does not satisfy a predetermined condition, the current ensemble model is determined as the final ensemble model. In a specific implementation, if the performance of the optimal candidate ensemble model is not superior to that of the current ensemble model, the current ensemble model is determined as the final ensemble model. In another specific implementation, if the performance of the optimal candidate ensemble model does not satisfy a predetermined performance standard, the current ensemble model is determined as the final ensemble model.

As such, the final ensemble model can be determined through automatic integration.

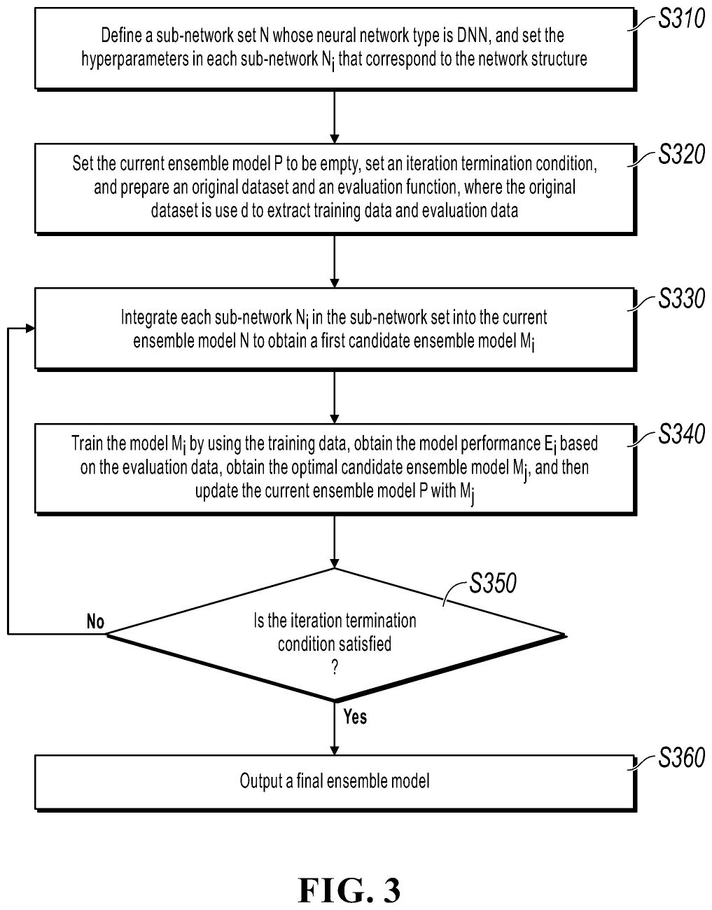

The following further describes the method with reference to a specific example. Specifically, in the following example, the DNN ensemble model is determined by using the previous method for determining an ensemble model. FIG. 3 is a block diagram illustrates a flowchart of a method for determining a DNN ensemble model, according to an implementation. As shown in FIG. 3, the method includes the following steps:

Step S310: Define a sub-network set N whose neural network type is DNN, and set the hyperparameters in each sub-network Nᵢ that correspond to the network structure.

Step S320: Set the current ensemble model P to be empty (that is, the initial value), set an iteration termination condition, and prepare an original dataset and an evaluation function, where the original dataset is used to extract training data and evaluation data.

In an implementation, the iteration termination condition includes the predetermined quantity of updates.

Step S330: Integrate each sub-network Nᵢ in the sub-network set N into the current ensemble model P to obtain a first candidate ensemble model Mᵢ.

Step S340: Train the model Mᵢ by using the training data, obtain model performance Eᵢ based on the evaluation data, obtain the optimal candidate ensemble model Mⱼ, and then update the current ensemble model P with Mⱼ.

Step S350: Determine whether the iteration termination condition is satisfied.

Further, if the iteration termination condition is not satisfied, jump to step S330. If the iteration termination condition is satisfied, step S360 is performed to output the last updated current ensemble model P as the final DNN ensemble model. In addition, in an example, performance evaluation results of the final DNN ensemble model can be output.

As such, the DNN ensemble model can be realized automatically.

In summary, according to the method for determining a computer-executed ensemble model disclosed in the implementations of the present specification, submodels can be automatically selected from some basic candidate submodels to form a high-performance ensemble model, and dependence on expert experience and manual intervention can be greatly alleviated. In particular, when the method is used to determine the DNN ensemble model, the complexity of artificial DNN design is greatly reduced. In addition, practices have shown that the DNN training method based on auto-integration can make the performance of the DNN ensemble model superior to that of a manually parameter-tuned DNN model.

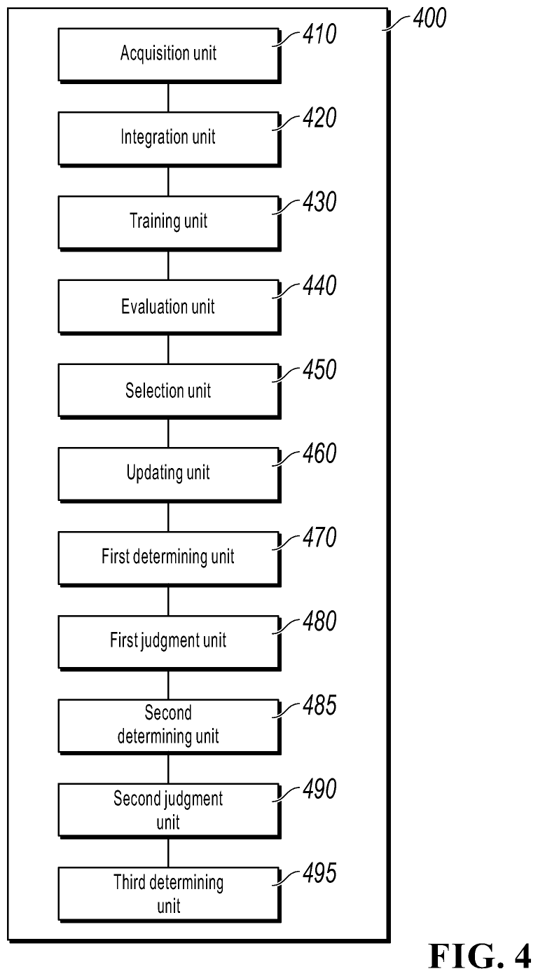

According to an implementation of another aspect, a device for determining a computer-executed ensemble model is provided, where the device can be deployed in any device, platform, or device cluster that has computation and processing capabilities. FIG. 4 is a structural diagram illustrating a device for determining an ensemble model, according to an implementation. As shown in FIG. 4, the device 400 includes:

an acquisition unit 410, configured to obtain a current ensemble model and a plurality of untrained candidate submodels; an integration unit 420, configured to integrate each of the plurality of candidate submodels into the current ensemble model to obtain a plurality of first candidate ensemble models; a training unit 430, configured to train at least the plurality of first candidate ensemble models to obtain a plurality of second candidate ensemble models after this training; an evaluation unit 440, configured to perform performance evaluation on each of the plurality of second candidate ensemble models to obtain corresponding performance evaluation results; a selection unit 450, configured to determine, based on the performance evaluation results, an optimal candidate ensemble model with optimal performance from the plurality of second candidate ensemble models; and an updating unit 460, configured to: update the current ensemble model with the optimal candidate ensemble model if the performance of the optimal candidate ensemble model satisfies a predetermined condition.

In an implementation, any two of the plurality of candidate submodels are based on the same or different types of neural networks.

In an implementation, the plurality of candidate submodels include a first candidate submodel and a second candidate submodel, and the first candidate submodel and the second candidate submodel are based on the same type of neural network, and have different hyperparameters for the neural network.

Further, in a specific implementation, the same type of neural network is a deep neural network (DNN), and the hyperparameters include the quantity of hidden layers in the DNN network structure, the quantity of neural units of each hidden layer in the plurality of hidden layers, and a manner of connection between any two of the plurality of hidden layers.

In an implementation, the training unit 430 is specifically configured to perform this training on the current ensemble model and the plurality of first candidate ensemble models if the current ensemble model is not empty.

In an implementation, the performance evaluation results include function values of a loss function that are corresponding to the plurality of second candidate ensemble models; and the selection unit 450 is specifically configured to determine a second candidate ensemble model corresponding to a minimum function value of the loss function as the optimal candidate ensemble model.

In an implementation, the performance evaluation results includes an area under a receiver operation characteristic (ROC) curve (AUC) value corresponding to each of the plurality of second candidate ensemble models; and the selection unit 450 is specifically configured to determine a second candidate ensemble model corresponding to a maximum AUC value as the optimal candidate ensemble model.

In an implementation, the updating unit 460 is specifically configured to update the current ensemble model with the optimal candidate ensemble model if the performance of the optimal candidate ensemble model is superior to that of the current ensemble model.

In an implementation, the device further includes a first determining unit 470, configured to determine the current ensemble model as the final ensemble model if the performance of the optimal candidate ensemble model does not satisfy a predetermined condition.

In an implementation, the device further includes: a first judgment unit 480, configured to determine whether a quantity of updates corresponding to a current ensemble model reaches a predetermined quantity of updates; and a second determining unit 485, configured to determine the updated current ensemble model as the final ensemble model if the quantity of updates reaches the predetermined quantity of updates.

In an implementation, the plurality of second candidate ensemble models after training include a retrained model obtained after this training is performed on the current ensemble model; and the device further includes: a second judgment unit 490, configured to determine whether the optimal candidate ensemble model is the retrained model; and a third determining unit 495, configured to determine the retrained model as the final ensemble model if the optimal candidate ensemble model is the retrained model.

In summary, according to the method for determining a computer-executed ensemble model disclosed in the implementations of the present specification, submodels can be automatically selected from some basic candidate submodels to form a high-performance ensemble model, and dependence on expert experience and manual intervention can be greatly alleviated. In particular, when the method is used to determine the DNN ensemble model, the complexity of artificial DNN design is greatly reduced. In addition, practices have shown that the DNN training method based on auto-integration can make the performance of the DNN ensemble model superior to that of a manually parameter-tuned DNN model.

According to an implementation of another aspect, a computer readable storage medium is further provided, where the computer readable storage medium stores a computer program, and when the computer program is executed on a computer, the computer is enabled to perform the method described with reference to FIG. 1, FIG. 2, or FIG.3.

According to an implementation of still another aspect, a computing device is further provided, including a memory and a processor, where the memory stores executable code, and when the processor executes the executable code, the method described with reference to FIG. 1, FIG. 2, or FIG.3 is implemented.

A person skilled in the art should be aware that, in one or more of the above examples, the functions described in the present specification can be implemented by using hardware, software, firmware, or any combination thereof. When these functions are implemented by software, they can be stored in a computer readable medium or transmitted as one or more instructions or code lines on the computer readable medium.

The specific implementations mentioned above further describe the object, technical solutions and beneficial effects of the present specification. It should be understood that the previous descriptions are merely specific implementations of the present specification and are not intended to limit the protection scope of the present specification. Any modification, equivalent replacement and improvement made on the basis of the technical solution of the present specification shall fall within the protection scope of the present specification.

What is claimed is:

1. A computer-implemented method comprising:
obtaining a current ensemble model and a plurality of untrained candidate submodels;
integrating each untrained candidate submodel of the plurality of untrained candidate submodels into the current ensemble model to obtain a plurality of first candidate ensemble models;
training, by at least one processor, the plurality of first candidate ensemble models to obtain a plurality of second candidate ensemble models;
generating, for the plurality of second candidate ensemble models, a plurality of performance evaluation results, respectively;
selecting, based on the plurality of performance evaluation results, an optimal candidate ensemble model with optimal performance from the plurality of second candidate ensemble models; and
updating the current ensemble model with the optimal candidate ensemble model, wherein the optimal performance of the optimal candidate ensemble model satisfies a predetermined condition.

2. The computer-implemented method of claim 1, wherein two or more models within the plurality of untrained candidate submodels, the plurality of first candidate ensemble models, or the plurality of second candidate ensemble models are based on the same or different types of neural networks.

3. The computer-implemented method of claim 1, wherein the plurality of untrained candidate submodels comprise a first candidate submodel and a second candidate submodel, and wherein the first candidate submodel and the second candidate submodel are based on the same types of neural networks and have different hyperparameters for the same types of neural networks.

4. The computer-implemented method of claim 3, wherein the same types of neural networks are deep neural networks (DNN), and the hyperparameters comprise a quantity of hidden layers in a DNN network structure, a quantity of neural units of each hidden layer in a plurality of hidden layers, and a manner of connection between any two of the plurality of hidden layers.

5. The computer-implemented method of claim 1, wherein training at least the plurality of first candidate ensemble models comprises:
determining the current ensemble model is not empty; and
responsive to determining the current ensemble model is not empty, training the current ensemble model.

6. The computer-implemented method of claim 1, wherein the performance evaluation results comprise a function value of a loss function corresponding to each second candidate ensemble model of the plurality of second candidate ensemble models; and
selecting, based on the performance evaluation results, the optimal candidate ensemble model with optimal performance from the plurality of second candidate ensemble models comprises:
selecting a second candidate ensemble model corresponding to a minimum function value of the loss function as the optimal candidate ensemble model.

7. The computer-implemented method of claim 1, wherein the performance evaluation results comprise an area under a receiver operation characteristic (ROC) curve (AUC) value corresponding to each of the plurality of second candidate ensemble models; and
selecting, based on the performance evaluation results, an optimal candidate ensemble model with optimal performance from the plurality of second candidate ensemble models comprises:
selecting a second candidate ensemble model corresponding to a maximum AUC value as the optimal candidate ensemble model.

8. A non-transitory, computer-readable medium storing one or more instructions executable by a computer system to perform operations comprising:
obtaining a current ensemble model and a plurality of untrained candidate submodels;
integrating each untrained candidate submodel of the plurality of untrained candidate submodels into the current ensemble model to obtain a plurality of first candidate ensemble models;
training, by at least one processor, the plurality of first candidate ensemble models to obtain a plurality of second candidate ensemble models;
generating, for the plurality of second candidate ensemble models, a plurality of performance evaluation results, respectively;
selecting, based on the plurality of performance evaluation results, an optimal candidate ensemble model with optimal performance from the plurality of second candidate ensemble models; and
updating the current ensemble model with the optimal candidate ensemble model, wherein the optimal performance of the optimal candidate ensemble model satisfies a predetermined condition.

9. The non-transitory, computer-readable medium of claim 8, wherein two or more models within the plurality of untrained candidate submodels, the plurality of first candidate ensemble models, or the plurality of second candidate ensemble models are based on the same or different types of neural networks.

10. The non-transitory, computer-readable medium of claim 8, wherein the plurality of untrained candidate submodels comprise a first candidate submodel and a second candidate submodel, and wherein the first candidate submodel and the second candidate submodel are based on the same types of neural networks and have different hyperparameters for the same types of neural networks.

11. The non-transitory, computer-readable medium of claim 10, wherein the same types of neural networks are deep neural networks (DNN), and the hyperparameters comprise a quantity of hidden layers in a DNN network structure, a quantity of neural units of each hidden layer in a plurality of hidden layers, and a manner of connection between any two of the plurality of hidden layers.

12. The non-transitory, computer-readable medium of claim 8, wherein training at least the plurality of first candidate ensemble models comprises:
determining the current ensemble model is not empty; and
responsive to determining the current ensemble model is not empty, training the current ensemble model.

13. The non-transitory, computer-readable medium of claim 8, wherein the performance evaluation results comprise a function value of a loss function corresponding to each second candidate ensemble model of the plurality of second candidate ensemble models; and
selecting, based on the performance evaluation results, the optimal candidate ensemble model with optimal performance from the plurality of second candidate ensemble models comprises:
selecting a second candidate ensemble model corresponding to a minimum function value of the loss function as the optimal candidate ensemble model.

14. The non-transitory, computer-readable medium of claim 8, wherein the performance evaluation results comprise an area under a receiver operation characteristic (ROC) curve (AUC) value corresponding to each of the plurality of second candidate ensemble models; and
selecting, based on the performance evaluation results, an optimal candidate ensemble model with optimal performance from the plurality of second candidate ensemble models comprises:
selecting a second candidate ensemble model corresponding to a maximum AUC value as the optimal candidate ensemble model.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
obtaining a current ensemble model and a plurality of untrained candidate submodels;
integrating each untrained candidate submodel of the plurality of untrained candidate submodels into the current ensemble model to obtain a plurality of first candidate ensemble models;
training, by at least one processor, the plurality of first candidate ensemble models to obtain a plurality of second candidate ensemble models;
generating, for the plurality of second candidate ensemble models, a plurality of performance evaluation results, respectively;
selecting, based on the plurality of performance evaluation results, an optimal candidate ensemble model with optimal performance from the plurality of second candidate ensemble models; and
updating the current ensemble model with the optimal candidate ensemble model, wherein the optimal performance of the optimal candidate ensemble model satisfies a predetermined condition.

16. The computer-implemented system of claim 15, wherein the plurality of untrained candidate submodels comprise a first candidate submodel and a second candidate submodel, and wherein the first candidate submodel and the second candidate submodel are based on different types of neural networks, the same types of neural networks, or the same types of neural networks with different hyperparameters.

17. The computer-implemented system of claim 16, wherein the same types of neural networks are deep neural networks (DNN), and the hyperparameters comprise a quantity of hidden layers in a DNN network structure, a quantity of neural units of each hidden layer in a plurality of hidden layers, and a manner of connection between any two of the plurality of hidden layers.

18. The computer-implemented system of claim 15, wherein training at least the plurality of first candidate ensemble models comprises:
determining the current ensemble model is not empty; and
responsive to determining the current ensemble model is not empty, training the current ensemble model.

19. The computer-implemented system of claim 15, wherein the performance evaluation results comprise a function value of a loss function corresponding to each second candidate ensemble model of the plurality of second candidate ensemble models; and
selecting, based on the performance evaluation results, the optimal candidate ensemble model with optimal performance from the plurality of second candidate ensemble models comprises:
selecting a second candidate ensemble model corresponding to a minimum function value of the loss function as the optimal candidate ensemble model.

20. The computer-implemented system of claim 15, wherein the performance evaluation results comprise an area under a receiver operation characteristic (ROC) curve (AUC) value corresponding to each of the plurality of second candidate ensemble models; and
selecting, based on the performance evaluation results, an optimal candidate ensemble model with optimal performance from the plurality of second candidate ensemble models comprises:
selecting a second candidate ensemble model corresponding to a maximum AUC value as the optimal candidate ensemble model.
